(19) United States
(12) Patent Application Publication
(10) Pub. No.: US 2003/0214128 A1
(43) Pub. Date: Nov. 20, 2003

(54) Ergonomic multimedia flipbook

(76) Inventors: Richard J. Roberts, Canton, MA (US); Andrew Mullen, Walpole, MA (US)

Correspondence Address: Choate, Hall & Stewart, Exchange Place, 53 State Street, Boston, MA, 02109, US

(21) Appl. No.: 10/440,533

(22) Filed: May 16, 2003

Related U.S. Application Data
(60) Provisional application No. 60/381,198, filed on May 17, 2002.

(51) Int. Cl. B42D 3/00

(52) U.S. Cl. 281/31

(57) ABSTRACT

A multimedia ergonomic flipbook for displaying sports images and optionally playing sounds corresponding to those images. The flipbook includes a plurality of pages with sequential images printed on both the obverse and reverse sides of the pages. For example, if the flipbook contains 32 pages, the pages can be flipped from page 1 to 32 to display one or more sets of animations, and the flipbook can be turned over and the pages can be flipped from pages 32 to 1 to display one or more sets of animations. The flipping ends of the pages can be cut stylistically so that the ends of the pages are straight or curved or any combination thereof so that the end of the flipbook is symmetrically beveled, which makes the pages of the flipbook easier to flip forwards or backwards. An example application of the inventions is a flipbook showing a particular player that could be shown making a great offensive play on one set of images and making a great defensive play on another set of images and with sound to accompany the animations.

### CROSS-REFERENCE TO RELATED APPLICATIONS

The present application claims priority to U.S. Provisional Application Serial No. 60/381,198, filed May 17, 2002, entitled “Ergonomic Multimedia Flipbook”, the teachings of which are incorporated herein by reference.

### FIELD OF THE INVENTION

The present invention is directed to the field of animation and more particularly to a method and apparatus for multimedia animation in a modified flipbook format.

### BACKGROUND OF THE INVENTION

Animated film has its roots in the flipbook (sometimes “flip book”) in which as one flips the pages, the figures drawn on the pages appear to move. The closer the various parts of a figure on one page are to the positions of corresponding parts of the figure on the preceding page, the slower the apparent motion of the figure, while the greater the displacement, the faster the apparent motion. A flipbook (or “kineograph”) can consist of pages or cards (collectively referred to hereinafter as “pages”) that are bound along one edge or otherwise permanently secured together in a stack so that the pages may be “flipped” to expose the images in rapid succession providing animation such as a moving image. FIG. 1 is an example of an end-user viewing a traditional square-ended flipbook 100 that is known in the prior art.

When flipbooks have pages of the same size, with a binding such as “perfect binding” to hold the pages together, the flipping side of the flipbook is not ergonomic, which is to say that the pages are not easy to flip. Prior art patents have tried to address this problem by cutting pages on the flipping side of a flipbook with various edge treatments such as tabs. While the result has sometimes been a flipbook that is easier to flip, in other words an ergonomic flipbook, the result has been at the expense of some other feature, such as reversibility or cost. FIG. 2 is a side-view of a non-reversible flipbook 100 with a beveled cut 102 that is known in the prior art.

U.S. Pat. No. 258,164 to Van Hoevenbergh (May 16, 1882) discloses an Optical Toy, the teachings of which are incorporated herein by reference. Van Hoevenbergh discloses trimming the edges of the pages in a flipbook in beveled form. While cutting the edges of the pages in a beveled form does produce an ergonomic flipbook with pages that are easy to flip, it does not produce a flipbook that is reversible.

U.S. Pat. No. 259,950 to Van Hoevenbergh (Jun. 20, 1882) discloses an Optical Toy, the teachings of which are incorporated herein by reference. Van Hoevenbergh discloses how to combine two or more series of pages by cutting tabs into the ends of the pages. In this way, flipping the upper tabs would display one animation, flipping the bottom taps would display another animation. While cutting the edges of the pages in a tabbed form does produce a reversible flipbook, it does not produce a flipbook that is ergonomic with pages that are easy to flip. In other words, the ends of the tabs are square as in a flipbook with pages that are all the same size.

Other relevant teachings of the prior art may be found in the following references, the teachings of all of which are incorporated herein by reference:

U.S. Pat. No. 575,761 to Short (Jan. 26, 1897) discloses a Means for Exhibiting Consecutive Pictures.

U.S. Pat. No. 5,84,311 to Marvin (Jun. 8, 1897) discloses a Mutoscope.

U.S. Pat. No. 614,367 to Casler (Nov. 15, 1898) discloses a Mutoscope.

U.S. Pat. No. 853,699 to Keen (May 14, 1907) discloses a Device for Producing Moving Picture Effects.

U.S. Pat. No. 1,787,592 to Owens (Dec. 18, 1926) discloses a Motion-picture Device. Owens discloses a reversible flipbook, but it achieves this result by folding pages in zigzag fashion. As such, the result is no longer a flipbook but a single accordion-like piece of paper lacking a binding.

U.S. Pat. No. 2,339,634 to Gross (May 4, 1942) discloses an Animated Book.

U.S. Pat. No. 2,607,263 to Lazarus (Jun. 28, 1947) discloses an Animated Picture Viewer and Pictures In Book Form.

U.S. Pat. No. 2,689,416 to Stoyanoff (Nov. 8, 1952) discloses a Hand Tachistoscope.

U.S. Pat. No. 3,159,405 to Brambier (Sep. 9, 1960) discloses Cards Selectively Usable For Playing a Game or for Producing a Motion Picture Effect.

U.S. Pat. No. 3,593,432 to Reynolds (Jul. 29, 1971) discloses a Teaching Aid for Coaching Sports and Manual Skills.

U.S. Pat. No. 3,740,128 to Adler (Nov. 1, 1971) discloses an Amusement Device.

U.S. Pat. No. 3,840,973 to Potter (Oct. 15, 1974) discloses a Transparency Viewing Cassette Unit.

U.S. Pat. No. 5,020,899 to Caston (Jun. 4, 1991) discloses a Hand Grip for a Sequential Card Pack Display Device. While Caston does disclose an ergonomic device for a flipbook, the device is a handgrip for the bound end of the flipbook, not an ergonomic feature of the flipping end of the flipbook.

U.S. Pat. No. 5,171,038 to Bowler (Dec. 15, 1992) discloses an Interactive Advertising Device.

U.S. Pat. No. 5,678,822 to Setteducati (Oct. 21, 1997) discloses Kinegraphic Playing Cards.

None of these prior art flipbooks are adapted to play sound.

There is, therefore, a need for a flipbook that overcomes the above-mentioned limitations, namely a flipbook that is: (1) reversible, which is to say a flipbook whose pages can be flipped forwards or backwards to produce a plurality of animations; (2) ergonomic, which is to say that the flipping ends of the flipbook includes pages with edge treatments such as angled beveled cards that make the pages easy to flip; and (3) that can be adapted to play sound to accompany the animation.

### SUMMARY OF THE INVENTION

A multimedia ergonomic flipbook for displaying sports images and optionally playing sounds corresponding to those images. The flipbook includes a plurality of pages with sequential images printed on both the obverse and reverse sides of the pages. For example, if the flipbook contains 32 pages, the pages can be flipped from page 1 to 32 to display one or more sets of animations, and the flipbook can be turned over and the pages can be flipped from pages 32 to 1 to display one or more sets of animations. The flipping ends of the pages can be cut stylistically so that the ends of the pages are straight or curved or any combination thereof so that the end of the flipbook is symmetrically beveled, which makes the pages of the flipbook easier to flip forwards or backwards. An example application of the inventions is a flipbook showing a particular player that could be shown making a great offensive play on one set of images and making a great defensive play on another set of images and with sound to accompany the animations.

In one aspect, the invention is a flipbook that is reversible, which is to say a flipbook whose pages can be flipped forwards or backwards to produce a plurality of animations. This result is achieved by printing images on the obverse and reverse pages of the flipbook. When this feature is combined with the ergonomic feature discussed below, a plurality of animations can be included on both the obverse and reverse sides of the pages of the flipbook.

In another aspect, the invention is an ergonomic flipbook, which is to say that the flipping end of the flipbook includes edge treatments such as angled beveled cuts that make the pages easy to flip.

In yet another aspect, the inventions is a flipbook that can be adapted to play sound to accompany the animation. This result can be achieved in a number of ways, such as including one or more microchips in the flipbook that are activated when the book is moved, squeezed, bent or otherwise resulting from the flipping action of the pages.

### BRIEF DESCRIPTION OF THE DRAWING

The invention is described with reference to the several figures of the drawing, in which:

FIG. 1 is an example of an end-user viewing a traditional square-ended flipbook that is typical of the prior art;

FIG. 2 is a side-view of a non-reversible flipbook with a beveled cut that is typical of the prior art;

FIG. 3 shows a symmetrically reversible pages of a flipbook according to one embodiment of the invention;

FIG. 4 is a top view of the flipbook shown in FIG. 3;

FIG. 5 is a top view of an ergonomic flipbook with semicircular-shaped edge cuts according to one embodiment of the invention;

FIG. 6 is a top view of an ergonomic flipbook with s-shaped edge cuts according to one embodiment of the invention;

FIG. 7 is a top view of an ergonomic flipbook with arch-shaped edge cuts according to one embodiment of the invention;

FIGS. 8A-8I show specific designs and edge profiles of flipbooks according to multiple embodiments of the invention;

FIG. 9 shows a sound-producing element positioned for activation on a flipbook according to one embodiment of the invention; and

FIG. 10 shows a flipbook having the features of reversibility, ergonomic use, and dual sound-producing elements according to one embodiment of the invention.

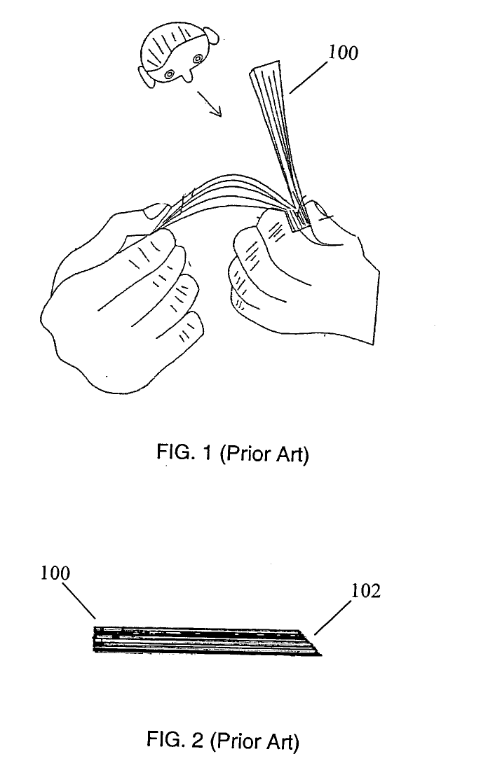

### DETAILED DESCRIPTION OF VARIOUS EMBODIMENTS

In order to create the flipbooks, still images are converted from existing moving images or original images are created. Using nonlinear digital editing, images from video are frozen into still images from motion picture film or video sources. The resultant images are known as JPEG images, for example. JPEG images can be manipulated with various software and hardware applications. The producer of the flipbooks has complete control of the image and can zoom-in or zoom-out, change colors, light levels, contrast levels, remove foregrounds and backgrounds, or isolate only the desired action.

Traditional 8 mm, 16 mm, 35 mm, and 70 mm motion picture film runs at 24 frames per second. Video is output at 30 frames per second. The invention uses a ratio of 1-to-1 or a factor as high as 8-to-1 for final flipbook output. Using a factor of 1-to-1 results in a flipbook with 32 sequential pages that would span a time period of 2.1 seconds. It takes only 1 second for a batter to hit a baseball and less than 2 seconds for a professional golfer to hit a golf ball, including the back swing and complete follow through. In the sport of rodeo, professional bull riders are required to stay on the animals for 8 seconds. An entire bull ride can be captured using an 8-to-1 factor.

The “factor formula” is the selection of 1 frame of action for every 8 frames originally captured. This formula allows for a full 8-second ride with good animation for the end-user of the flipbook. The 8-to-1 factor formula is the practical limit for good reproduction of an action sequence. In the sport of professional drag racing, races typically last under 5 seconds. A complete race could be captured using a factor of 6-to-1 or 5-to-1.

After capturing images, the images are manipulated to produce a flipbook with the smoothest presentation of the desired action. All images are manipulated to create additional motion within motion of the event, including zoom-in or zoom-out effects. Every aspect of the images is enhanced to create additional appeal for the end-user. Original backgrounds or foregrounds are eliminated as required by various licensing agreements. Images are stylized when deemed necessary to create even more eye appeal. Some flipbooks include special effects such as holographs or add-ons such as interactive CD-ROMs.

The advantages of a reversible flipbook include the following. For end-users, multiple animations can be displayed. For example, in a baseball flipbook, a particular player could be shown making a great offensive play on one set of images and making a great defensive play on another set of images. For the producers of flipbooks, including images on both the obverse and reverse sides of the pages, as opposed to just one side, results in a product with more animations in the same physical package.

The advantages of an ergonomic flipbook include the following. Traditional square-ended flipbooks can be difficult for end-users to flip. A flipbook with the flipping end of the flipbook having edge treatments such as angled beveled cuts makes the pages easier to flip. In addition, this results in the flipbook product having a longer product lifetime, since end-users of the ergonomic flipbook do not have to bend the flipbook as much, as is common with traditional square-ended flipbooks, in order to produce the animation.

The advantages of a multimedia flipbook include the following. When sound is added to a flipbook by including one or more microchips in the flipbook or otherwise, end-users are presented with a much more memorable and enjoyable experience than with a flipbook that does not include sound.

Referring now to the figures of the drawing, the figures constitute a part of this specification and illustrate exemplary embodiments of the invention. It is to be understood that in some instances various aspects of the invention may be shown exaggerated or enlarged to facilitate an understanding of the invention.

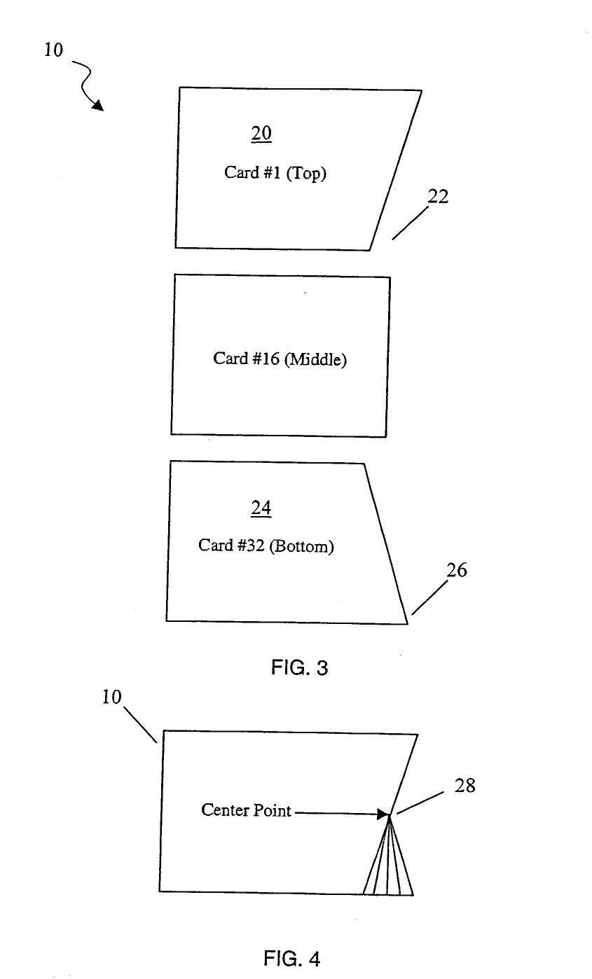

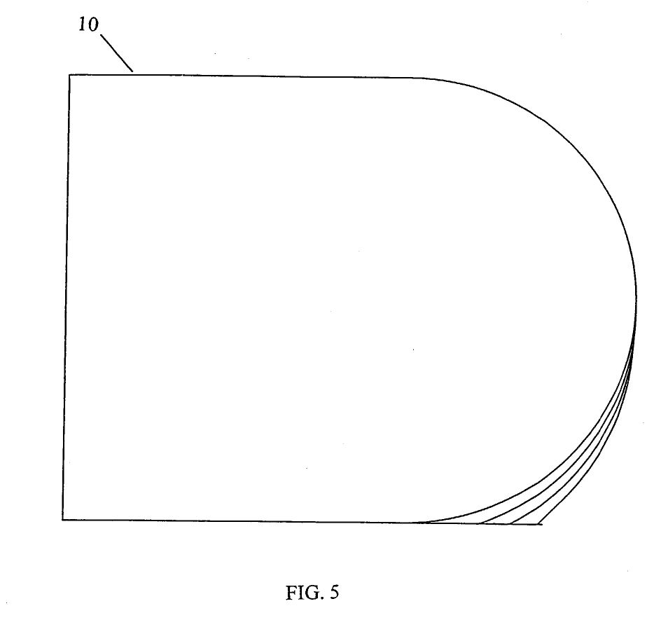

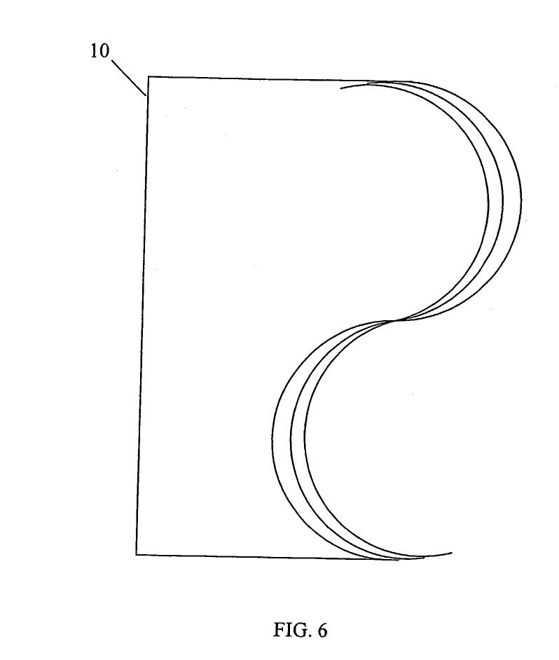

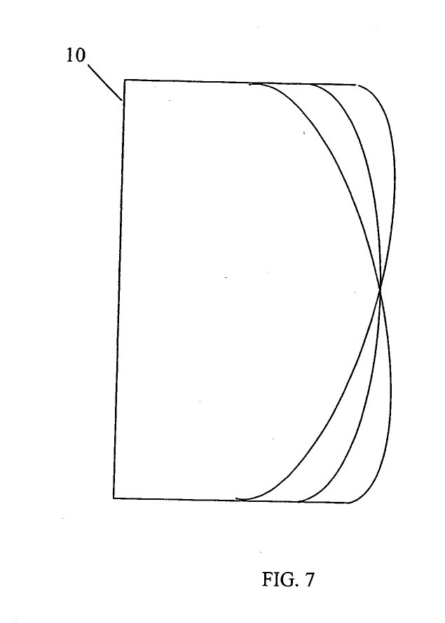

In one embodiment of the invention, the side of a flipbook 10 opposite the binding is cut at an angle of approximately 45 degrees so that (for a right-handed flipbook) the lower-right edge 22 of the top-most page 20 is shorter than the second page, the lower-right edge of the second page is shorter than the third, and so on until the lower right edge 26 of the bottom page 24 is the longest. This angled cut makes both sides of the flipbook 10 more easily flipable. An example of this embodiment is shown in FIGS. 3 and 4. Note that many types of stylistic cuts can be made to the pages of the flip book to make it symmetrically reversible, and that the lines and curves formed by the cut rotate around a center point 28 as shown in FIG. 4. Examples of the types of symmetrically reversible cuts include, but are not limited to, a straight cut as shown in FIGS. 3 and 4, a semicircular cut, as shown in FIG. 5, an s-shaped cut as shown in FIG. 6, and an arch-shaped cut as shown in FIG. 7. Note also that in the figures the flipbooks are not drawn to scale and that the pages are shown as if they were transparent to highlight the edge cuts.

In another embodiment of the invention, a flipbook has a binding on one edge and has two animations: one printed on the front side (obverse) of the pages and the other printed on the backside (reverse) of the pages.

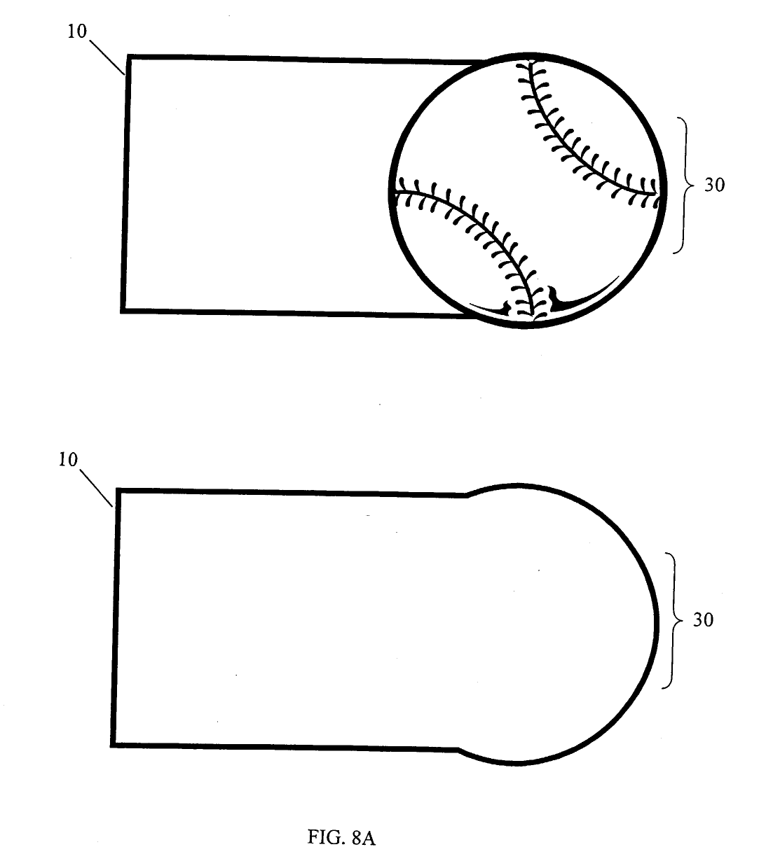

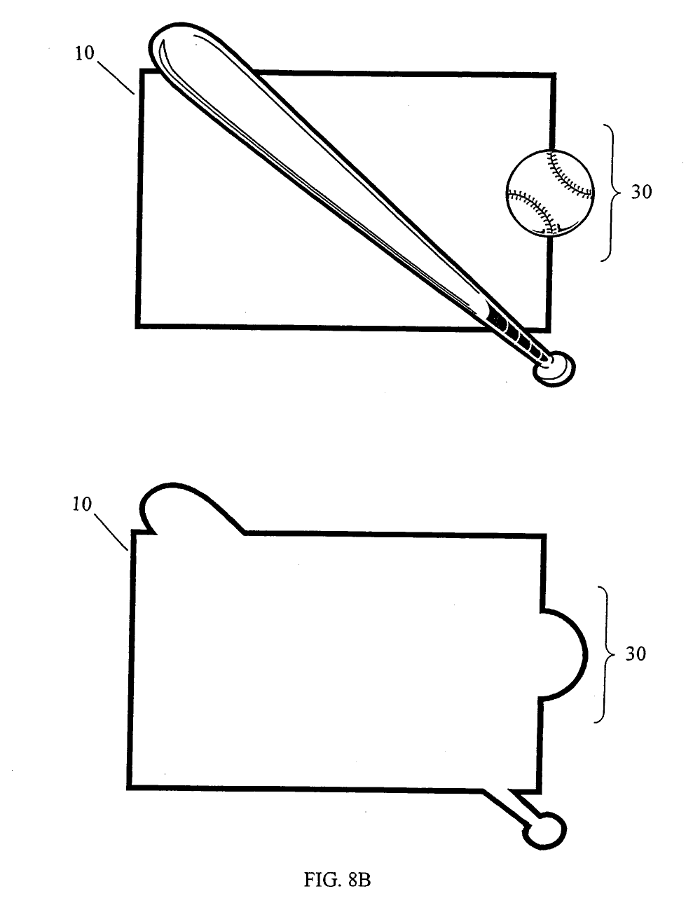

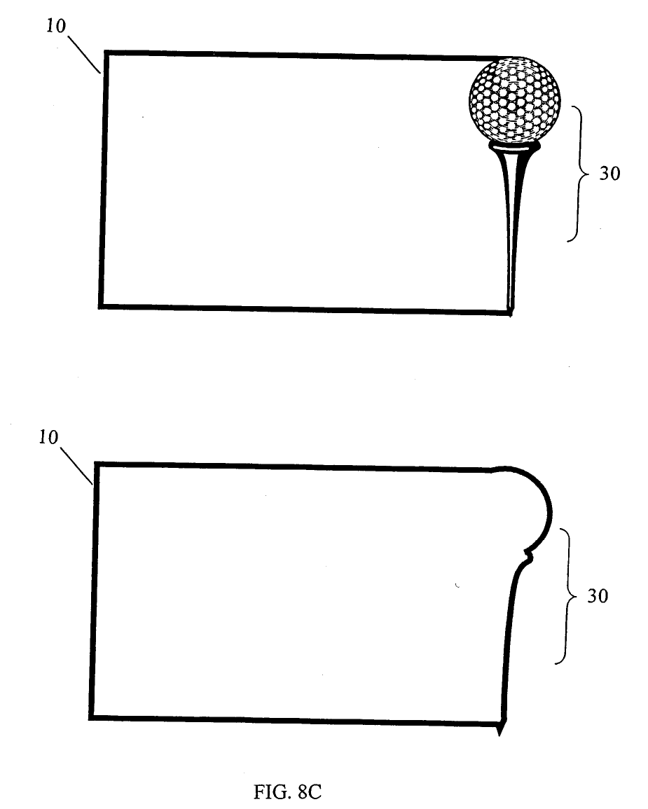

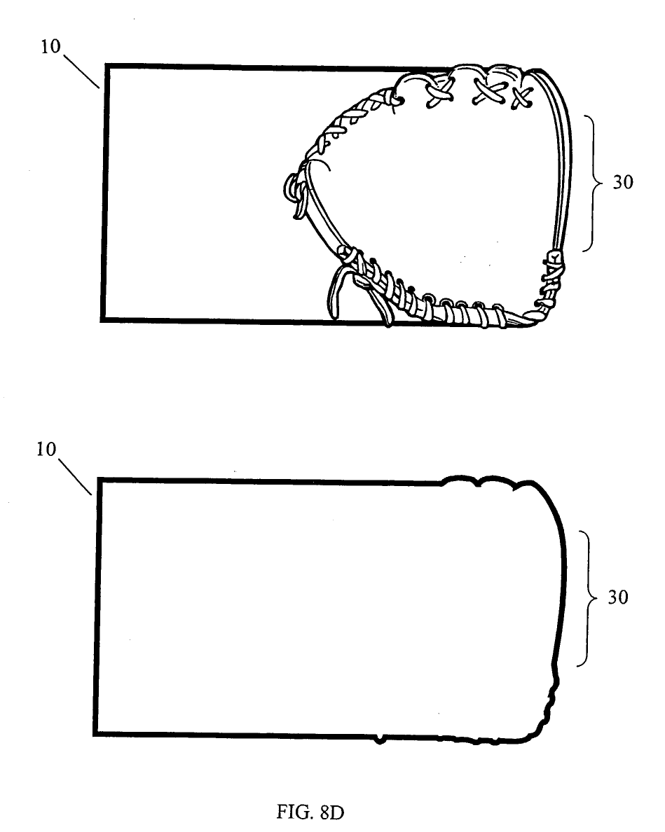

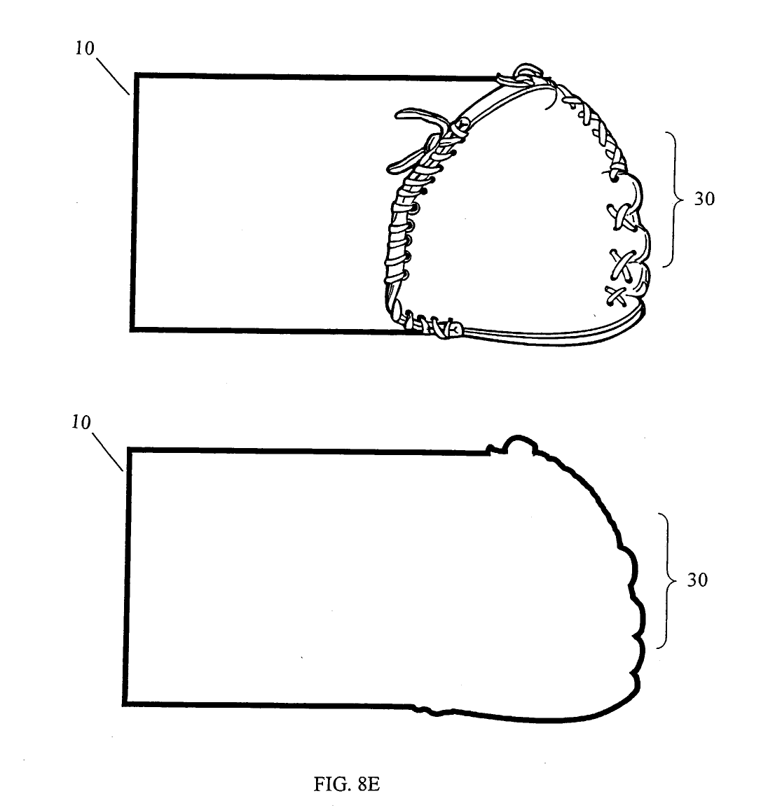

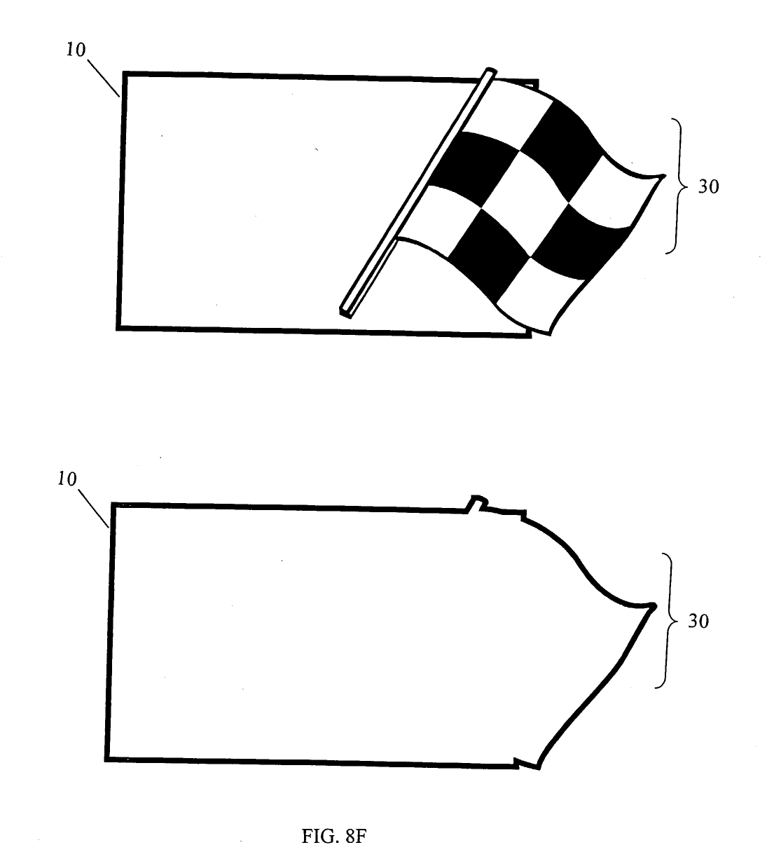

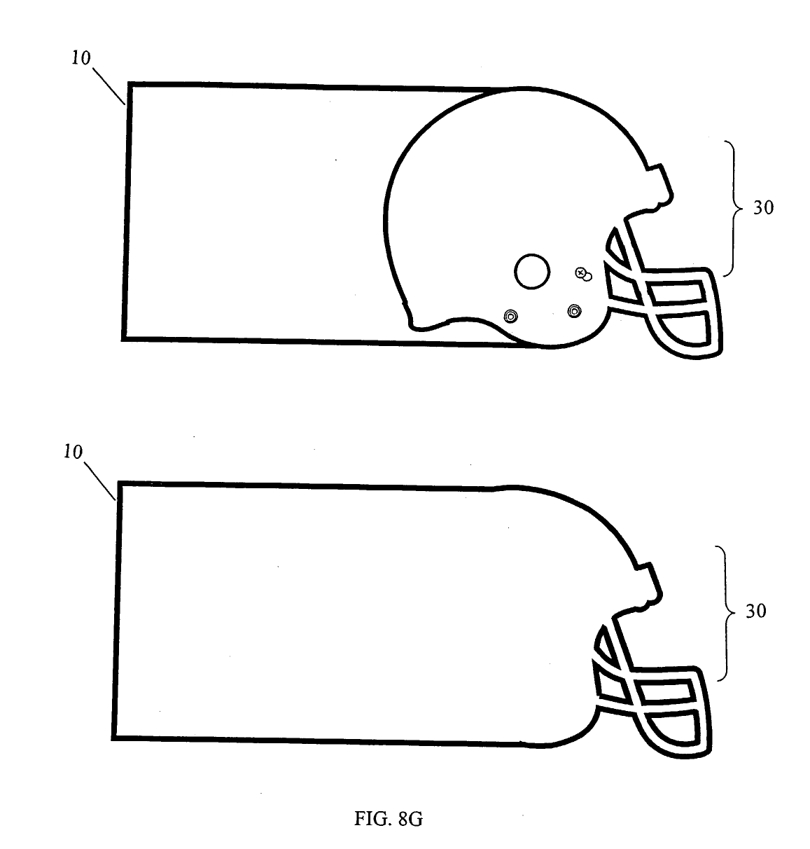

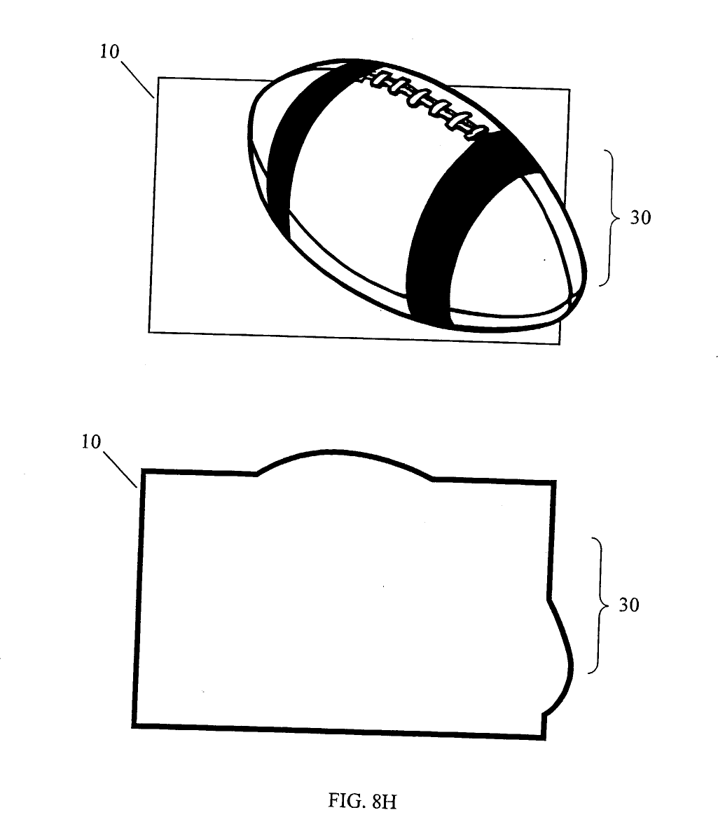

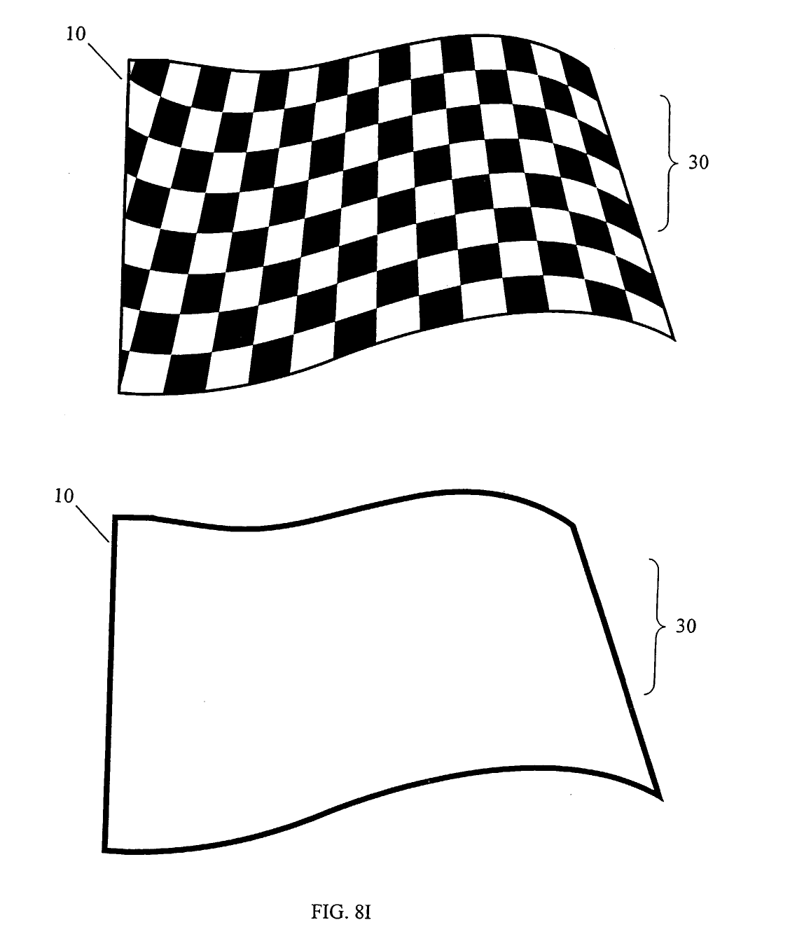

FIGS. 8A-8I show flipbooks 10 having various die cut designs and flipbook edge profiles 30 for a number of sporting events. The sporting event flipbook designs are shown as a baseball (FIG. 8A), a bat and baseball (FIG. 8B), a golf ball on a tee (FIG. 8C), a baseball glove in a vertical orientation (FIG. 8D), a baseball glove in a horizontal orientation (FIG. 8E), a small checkered flag (FIG. 8F), a football helmet (FIG. 8G), a football (FIG. 8H), and a large checkered flag covering the entire face of the flipbook (FIG. 8I).

In a preferred embodiment of the invention, thumb tabs, like those found in unabridged dictionaries, are cut into the flipping side of the flipbook. It is contemplated that thumb tabs or other features implemented to aid in the operation of the flipbook by a user can be incorporated into the visual designs. The elements of the visual designs, such as those shown in FIGS. 8A-8I, forming the edge profiles 30 that extend beyond the boundaries of the rectangular body of the flipbook 10 can be utilized as tabs that aid in the manipulation of the flipbook by the user. For example, the profile edges of the baseball gloves shown in FIGS. 8D and 8E or the football helmet shown in FIG. 8G not only visually communicate the subject of the animation but are configured such that a user may utilize the profile edges as tabs to aid in the flipping action of the flipbook.

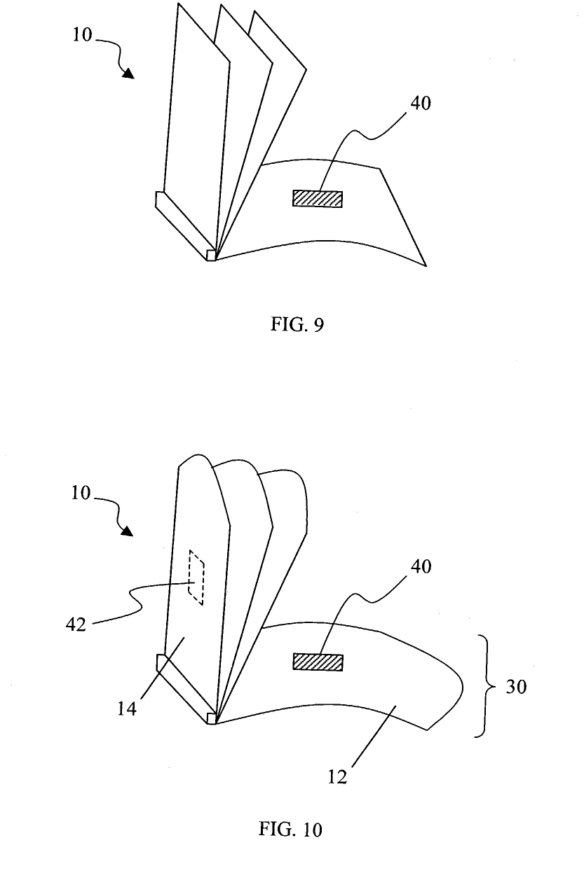

In another embodiment of the invention, a sound-producing element, such as a microchip, is included in the flipbook to provide an auditory component to accompany the visual animation. The microchip is imbedded in one of the pages or in the binding and is activated by movement, pressure, squeezing, bending, or otherwise due to the page flipping action. Activating the microchip plays the sound that accompanies the animation. FIG. 9 illustrates a sound-producing element 40 positioned for activation on a flipbook 10 according to one embodiment of the invention. In this embodiment, the sound-producing element 40, such as a microchip, is shown positioned on the back cover 12 of the flipbook 10. The microchip 40 is activated by the bending of the cover 12 that results from a user flipping the flipbook 10. In a preferred embodiment, the microchip 40 is positioned on the cover 12 in an area subject to the maximum bending action during the flipping of the flipbook 10. Further, in another preferred embodiment, the sound emanating from the microchip corresponds to the subject of the animation. The microchip may comprise musical, sound and voice modules. Such sound examples include the voice of an announcer, the crack of a bat, an Umpire calling a strike, the sound of a race track, and a tackle on the football field. Examples of sound-producing elements that have been utilized in the prior art in non-flipbook formats include U.S. Pat. No. 5,209,665 to Billings et al. and U.S. Pat. No. 5,631,883 to Li, the teachings of both of which are incorporated herein by reference.

In other embodiments, the microchip or other sound-producing element may be incorporated within the pages, on the front cover, or in the edge profiles of the designs such as those shown in FIGS. 8A-8I. Further, instead of a bending action activating the sound-producing element, the element may be activated by a squeezing action of the user or by the force of the pages striking one another during operation. Other embodiments for activation of a sound-producing element will be known to those of ordinary skill in the art and are contemplated herein.

In another embodiment of the invention, the edge treatment features of the embodiments as shown in FIGS. 5-7 are incorporated with the designs of FIGS. 8A-8I and may also be incorporated with the multimedia feature embodiment shown in FIG. 9. Further, in a flipbook having combined features, it is contemplated that an additional sound-producing element may be included such that two sound-producing elements are positioned on the front and back covers. When a reversible flipbook is flipped in one direction, the sound-producing element on one cover is activated. When the flipbook is reversed and flipped in the other direction, the sound-producing element on the other cover is activated.

For example, in one direction, the flipbook contains an animation feature of a batter hitting a ball. When the flipbook is flipped to animate this sequence, the microchip that is activated by the bending of one cover produces a sound of the crack of the bat. When the flipbook is reversed, the reverse pages of the flipbook contain an animation feature of a runner sliding into a catcher at home plate. When this “reverse” flipbook is flipped to animate this animation sequence, the second microchip on the other cover (which was formerly the front cover but is now the back cover for the “reverse” sequence) is activated to produce the sound of an umpire saying “safe” or “you're out”. A flipbook according to this embodiment may combine one more of the features including flipbook reversibility, ergonomic use in both flipping directions, and multiple sound-producing elements that are individually activated depending the flipping direction and the corresponding cover that is bent.

FIG. 10 illustrates a flipbook 10 having combined features. One sound-producing element 40 is positioned adjacent to back cover 12. A second sound-producing element 42 is positioned adjacent to front cover 14. The pages of the flipbooks may comprise designs and edge profiles 30 that visually communicate the subject matter of the animation while the edge profiles 30 themselves may serve as mechanisms to aid a user in flipping the flipbook 10. In utilizing the second sound-producing element 42, the flipbook 10 may be reversible in that it contains a reverse animation sequence if flipped in the reverse direction and the edge profiles 30 of the flipbook 10 may by symmetrically reversible. It is also contemplated that one sound-producing element may be configured and positioned to produce multiple sounds depending on the direction of flipping.

Other embodiments of the invention will be apparent to those skilled in the art from a consideration of the specification or practice of the invention disclosed herein. It is intended that the specification and examples be considered as exemplary only, with the true scope and spirit of the invention being indicated by the following claims.

What is claimed is:

1. A ergonomic multimedia flipbook, comprising:
a plurality of pages positioned between a front cover and a back cover;
a plurality of animation frames in which each animation frames differs from another one and wherein each animation frame is configured on each page of the plurality of pages such that when a user flips said plurality of pages said animation frames produce a visual animation sequence; and
a profile edge design positioned on an edge of each of said plurality of pages, wherein said profile edge design is configured to visually resemble a subject matter of said visual animation sequence and is adapted to aid the user in flipping said plurality of pages.

2. The flipbook of claim 1, wherein said profile edge design is a semicircular portion resembling a baseball.

3. The flipbook of claim 1, wherein said profile edge design is a plurality of ridges resembling a portion of a baseball glove.

4. The flipbook of claim 1, wherein said profile edge design is an oblong portion resembling an end of a football.

5. The flipbook of claim 1, wherein said profile edge design is a wavy portion resembling an edge of a flag.

6. The flipbook of claim 1, wherein said profile edge design is a grid portion resembling a front of a football helmet.

7. The flipbook of claim 1, further comprising:
a sound-producing element positioned adjacent to said back cover,
wherein said sound-producing element is activated by the flipping of said plurality of pages.

8. The flipbook of claim 7, wherein said sound-producing element is a microchip.

9. The flipbook of claim 7, wherein said sound-producing element is activated by a bending of said back cover by said user during the flipping of said plurality of pages.

10. The flipbook of claim 9, wherein said sound-producing element is positioned on said back cover in an area of maximum bending of said back cover during the flipping of said plurality of pages.

11. The flipbook of claim 1, wherein said plurality of pages are stacked and include edge cuts such that said flipbook is symmetrically reversible.

12. The flipbook of claim 7, wherein said plurality of pages are stacked and include edge cuts such that said flipbook is symmetrically reversible.

13. An ergonomic multimedia flipbook, comprising:
a plurality of pages positioned between a front cover and a back cover;
a plurality of animation frames in which each animation frame differs from another one and wherein each animation frame is configured on each page of the plurality of pages such that when a user flips said plurality of pages said animation frames produce a visual animation sequence; and
wherein said plurality of pages are stacked and include edge cuts such that said flipbook is symmetrically reversible.

14. The flipbook of claim 13, wherein said edge cuts include lines formed to be symmetrical about a center point.

15. The flipbook of claim 13, wherein said edge cuts include semi-circular edge cuts.

16. The flipbook of claim 13, wherein said edge cuts include s-shaped edge cuts.

17. The flipbook of claim 13, wherein said edge cuts include arch-shaped edge cuts.

18. The flipbook of claim 13, further comprising two sound-producing elements, a first sound-producing element positioned adjacent to said back cover and a second sound-producing element positioned adjacent to said front cover, wherein said first sound-producing element is activated by the flipping action in one direction and said second sound-producing element is activated by the flipping action when reversing said flipbook.

19. A ergonomic multimedia flipbook, comprising:
a plurality of pages positioned between a front cover and a back cover;
a plurality of animation frames in which each animation frames differs from another one and wherein each animation frame is configured on a single page of the plurality of pages such that when a user flips said plurality of pages said animation frames produce a visual animation sequence; and
a sound-producing element positioned adjacent to said back cover, wherein said sound-producing element is activated by the flipping of said plurality of pages.

20. The flipbook of claim 19, wherein said sound-producing element is a microchip.

21. The flipbook of claim 19, wherein said sound-producing element is activated by a bending of said back cover by said user during the flipping of said plurality of pages.

22. The flipbook of claim 21, wherein said sound-producing element is positioned on said back cover in an area of maximum bending of said back cover during the flipping of said plurality of pages.

23. The flipbook of claim 19, further comprising a second sound-producing element positioned adjacent to said front cover.

24. The flipbook of claim 23, wherein said first sound-producing element is activated by the flipping action in one direction and said second sound-producing element is activated by the flipping action when reversing said flipbook.
